(19) United States
(12) Patent Application Publication
(10) Pub. No.: US 2010/0036693 A1
(43) Pub. Date: Feb. 11, 2010

(54) FLOW TRACKING OF ENVIRONMENTAL SUBSTANCES

(75) Inventor: David Probst, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/188,968

(22) Filed: Aug. 8, 2008

(51) Int. Cl. G06Q 10/00

(52) U.S. Cl. 705/7

(57) ABSTRACT

An environmental tracking system provides facilities for modeling the processes of an organization that have an impact on the environment. The environmental tracking system allows each process to be modeled by its input substances and its resulting output substances. The environmental tracking system allows links to be established between the processes, such as indicating a source process and a destination process for a substance. Each process performs a conversion of input substances to output substances in accordance with conversion parameters specified for the process. Once the model of the processes of an organization is established, the environmental tracking system can track the flow of substances through the organization based on the model.

### BACKGROUND

Enterprise Resource Planning (“ERP”) refers to the field of integrating most of the data and processes of an organization into a unified system. A typical ERP system uses multiple components of computer software and hardware to achieve the integration. Most ERP systems use a unified database to store data for the various system components. Prior to integrating an ERP system, most organizations used separate applications for accounting, human resources, and other business functions. ERP systems typically attempt to cover all of the basic functions of an organization, regardless of the organization's business or charter. For example, ERP systems may cover manufacturing, warehousing, logistics, information technology, accounting, human resources, marketing, payroll, and strategic management. Business, nonprofit organizations, nongovernmental organizations, governments, and other organizations utilize ERP systems.

One of the functions not typically supported by ERP systems is the tracking of pollution resulting from the operation of an organization. Organizations may have a need to track such pollution, or more generally, the release of any substances (e.g., CO₂ and plastics) into the environment, also referred to as the “ecosphere.” The need to track the release of substances may arise from government regulations, pressures from shareholders or environmental groups, general concerns for the environment, and so on. By accurately tracking the release of substances, the organization may be able to identify where changes in the operations can be made to minimize the release of substances or how to respond more effectively to regulations and pressures.

In addition to tracking the release of substances into the ecosphere, organizations may want to track the resources they have consumed or extracted from the ecosphere. The resources may include energy, raw materials, transportation resources, and so on. By tracking such resources, an organization may be able to get a better picture of the overall consumption of their operations. By reducing its overall consumption, the organization may be able to reduce its costs and its impact on the environment.

Some attempts have been made to provide facilities that can help an organization track the release of substances and the resources consumed. The National Renewable Energy Laboratory (“NREL”), which is funded by the U.S. government, performs research and development aimed at advancing the energy goals of the United States. The NREL is administering a Life-Cycle Inventory (“LCI”) Database Project. The goal of the LCI Database Project is to create data modules that quantify the material and energy flowing into and out of the environment for common unit processes. These data modules can then be used to facilitate a Life-Cycle Impact Assessment (“LCIA”) of an organization's operation. These data modules, however, only provide information that can be used to assess various unit processes of an organization. These data modules do not model the operation of any organization, however, the information from the data modules can be used in such modeling.

### SUMMARY

A method and system for tracking the environmental impact of an organization is provided. An environmental tracking system provides facilities for modeling the processes of an organization that have an impact on the environment. The environmental tracking system allows each process to be modeled by its input substances, intermediate substances, and its resulting output substances. The environmental tracking system allows links to be established between the processes indicating a source process and a destination process for a substance. Each process performs a conversion of input substances to output substances in accordance with conversion parameters specified for the process. The model for an organization thus describes the processes (i.e., internal and external processes), the links between the processes, and any conversions resulting from the processes of the organization.

Once the model of the processes of an organization is established, the environmental tracking system can track the flow of substances through an organization. The environmental tracking system allows a user to specify initial input flows of incoming substances and from where the incoming substances are purchased, acquired, extracted, returned from customers, and/or measured or metered to be used in the model. The environmental tracking system uses the incoming substance information as an initial input flow for a process of the organization that is defined by the model. The environmental tracking system can then transitively calculate the output substances of each process. Alternatively, a process can have output substances specified in a way that is not directly linked to an incoming substance. By tracking the flow of substances according to the established model, the environmental impact system can provide an organization with the overall impact that the organization has on the environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a model of a simple manufacturing organization in some embodiments of an environmental impact system.

FIG. 2 illustrates a display page for inputting conversion information for a process in some embodiments of the environmental impact system.

FIG. 3 is a block diagram illustrating components of an environmental impact system in some embodiments.

FIG. 4 is a block diagram illustrating a database for storing a model and associated flows in some embodiments of an environmental impact system.

FIG. 5 is a flow diagram that illustrates the processing of an input invoice component of an environmental impact system in some embodiments.

FIG. 6 is a flow diagram that illustrates the processing of a process flows component of an environmental impact system in some embodiments.

FIG. 7 is a flow diagram that illustrates the processing of the generate report component of an environmental impact system in some embodiments.

### DETAILED DESCRIPTION

A method and system for tracking the environmental impact of an organization via an enterprise resource planning (“ERP”) system or other system handling business processes in a structured fashion is provided. In some embodiments, an environmental tracking system is integrated with an ERP system or other system. The environmental tracking system provides facilities for modeling the processes of an organization that have an impact on the environment. For example, a manufacturer of a product may have several processes that are either directly or indirectly used by the manufacturer. The manufacturer may have a direct process that inputs a certain raw material and electricity and outputs a finished product with some sort of waste byproduct. The electricity used by the manufacturer may be represented by an indirect process that is performed by an electrical utility. For example, the indirect process may include the input of coal and the output of electricity and various greenhouse gases, such as carbon dioxide. The tracking of indirect processes allows an organization to track its overall impact on the environment. The environmental tracking system allows each process to be modeled by its input substances and its resulting output substances. Such processes are referred to as being part of the “technosphere” in the sense that they are part of the manmade environment rather than part of the “ecosphere,” which is a natural environment.

The environmental tracking system allows links to be established between the processes indicating a source process and a destination process for a substance. For example, a user may establish a link between a manufacturing process and a scrubbing process for greenhouse gases. The scrubbing process aims at reducing the greenhouse gases that are ultimately released into the ecosphere. The scrubbing process may have associated parameters that determine, for a certain amount of input greenhouse gases, the resulting greenhouse gases that are output into the ecosphere. Each process thus performs a conversion of input substances to output substances in accordance with the parameters. The model for an organization thus describes the processes, the links between the processes, and any conversions resulting from the processes of the organization.

Once the model of the processes of an organization and surrounding processes of the environment, vendors, customers, and so on is established, the environmental tracking system can track the flow of substances through an organization based on the model. The environmental tracking system allows the user to specify various initial input flows into the model. For example, an initial input flow may be an amount of electricity or a certain raw material used by the organization during a certain time. The environmental tracking system may allow these initial input flows to be input as part of normal bill payment, delivery logs, and so on, of the ERP system. For example, when an organization receives an electrical bill, the ERP system could be used to input information relating to the bill into the model, including the amount of electricity reported as being used. The environmental tracking system uses that information as an initial input flow for a process of the organization as defined by the model. The environmental tracking system can then transitively calculate the output substances for each process of the organization, which, as they are defined by the links, may be input into other processes of the organization. For example, an input substance of coal may be burned (i.e., converted) by a manufacturing process that outputs greenhouse gases. Those greenhouse gases may then become input substances for a scrubbing process that performs a conversion to reduce the greenhouse gases and outputs a reduced amount of greenhouse gases and a solid waste byproduct. The reduced greenhouse gases and the solid waste byproduct may then become input substances for a process representing the atmosphere and a dump, respectively. By tracking the flow of substances according to the established model, the environmental impact system can provide an organization with an overall impact that the organization has on the environment.

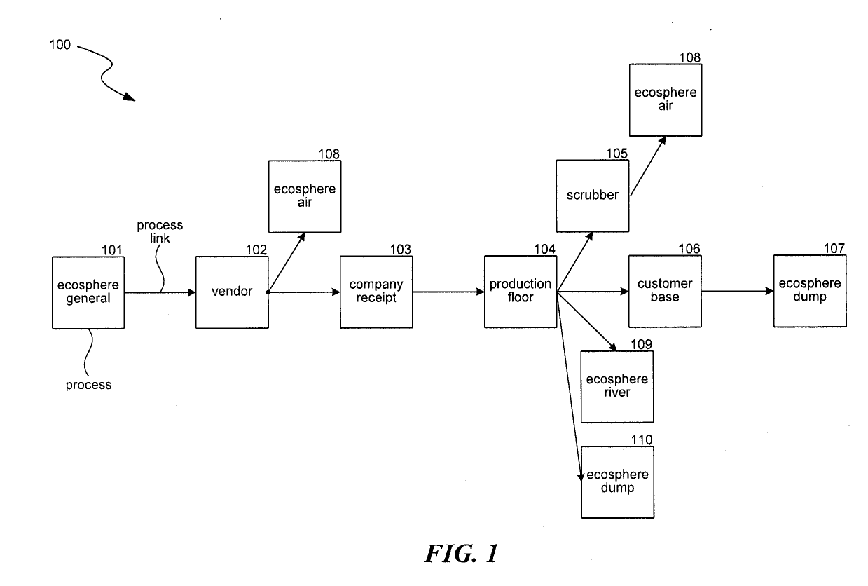

FIG. 1 is a block diagram illustrating a model of a manufacturing organization in some embodiments of an environmental impact system. A model 100 includes processes 101-110. Processes 102, 103, 104, and 106 represent technosphere processes, and processes 101, 107, 108, 109, and 110 represent ecosphere processes. Processes 103, 104, and 105 are internal processes of the organization, and the other processes are external processes to the organization. The lines between each process indicate an identified substance outflow from one process and a substance inflow into another process, as indicated by the direction of the arrow. For example, process 104 inputs a substance from process 103 and outputs substances to processes 105, 106, 109, and 110. The model includes an initial input flow from an ecosphere general process 101, which may represent the extraction of a raw material (e.g., coal or iron) from the environment. The ecosphere general process outputs the raw material, which is input into a vendor process 102. The vendor process may convert the raw material into a manufactured substance that is output from the vendor process 102 and input into a company receipt process 103. The vendor process 102 may also output a substance (e.g., CO₂) that is input into an ecosphere air process 108. The company receipt process 103 may represent the receipt and inventorying of the manufactured substance and eventual output of the manufactured substance as input into a production floor processes 104. The production floor process 104 may represent the conversion of the manufactured substance into a finished product, which is then input into a customer base process 106 when it is sold. The production floor process 104 may also output greenhouse gases that are input into a scrubber process 105 with its output greenhouse gases being released in to the ecosphere air process 108. The production floor process 104 may also output waste into an ecosphere river process 109 and an ecosphere dump process 110 near the manufacturer's location. The customer base process 106 may consume the finished product resulting in waste that is input into an ecosphere dump 107 near the customer's location.

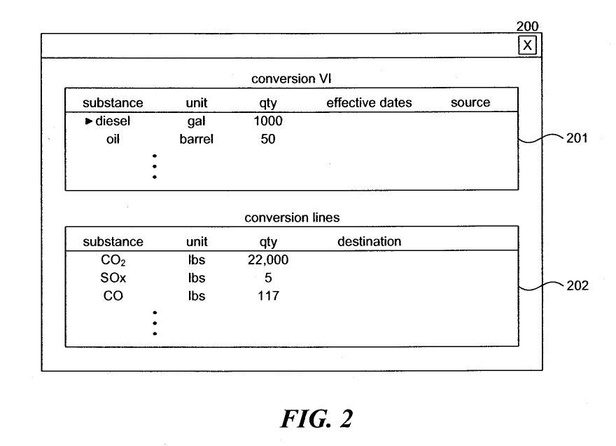

FIG. 2 illustrates a display page for inputting conversion information for a process in some embodiments of the environmental impact system. A display page 200 includes an input substance area 201 and an output substance area 202. The input substance area includes rows for inputting a substance, a common unit of the substance, and a common quantity of the substance. For example, the currently selected row (indicated by the arrow) corresponds to 1000 gallons of diesel fuel. The row may also include effective dates for the conversion and source of the substance of the conversion. The output substance area contains a row for each substance that is output from the conversion of the selected substance, also referred to as a conversion line. For example, since diesel fuel is the selected substance, the output substances include CO₂, SOx, and CO. The units and quantities in each row for each specific output substance indicate the amount of a substance that is output from the conversion of the specific quantity of units of the input substance. For example, the conversion of a thousand gallons of diesel fuel results in 22,000 pounds of CO₂, 5 pounds of SOx, and 117 pounds of CO.

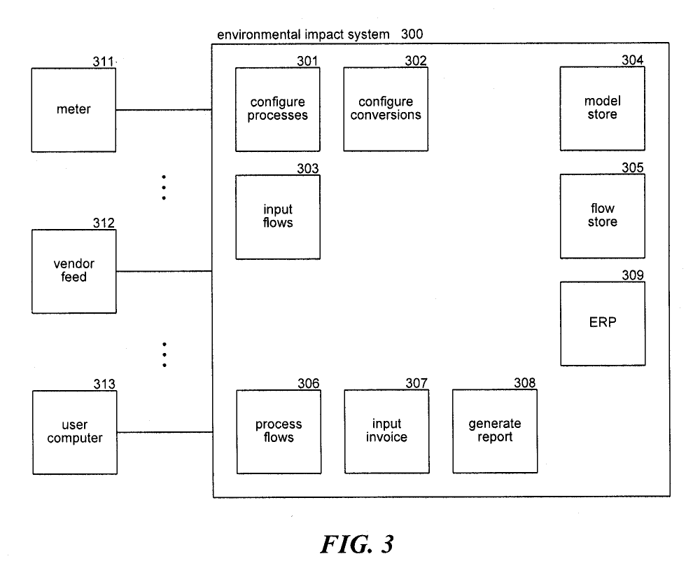

FIG. 3 is a block diagram illustrating components of an environmental impact system in some embodiments. The environmental impact system 300 includes a configure processes component 301, a configure conversions component 302, and an input flows component 303. The environmental impact system also includes a model store 304, and a flows store 305. The configure process component and the configure conversion component are used to define a model, which is stored in the model store. The configure process component controls defining of process and their links. The configure conversions component allows a user to specify which input substances are converted into which output substances. The input flows component allows a user to input initial flows into a model. The initial flows may be input via meters 311, vendor feeds 312, or user computers 313. The meters may be attached to equipment of the organization that measures the flow of a substance (e.g., natural gas or water). The vendor feeds may allow vendors or other suppliers of substances to manually or automatically load input flow information into the environmental impact system. The user computers allow users to manually input flow information into the environmental impact system (e.g., from a utility company invoice). The flows store maintains information relating to the initial input flows of substances and the resulting flow of substances from the subsequent conversions of the initial input flows. The environmental impact system also includes a process flows component 306, an input invoice component 307, a generate report component 308, and an ERP system 309. The process flows component may be invoked automatically when an initial flow is input into a process or may be invoked periodically to process any flows that have been input since the process flows component was last invoked. The process flows component uses the model information in the model store to generate any flows resulting from the conversion of an initial input flow and can be transitively invoked to process any subsequent input flows that are generated by the conversions. The input invoice component may be a sub-component of the ERP system used for inputting invoice information resulting in subsequent storing of initial input flows in the flows store linked to financial data of a received invoice. The generate report component is invoked to generate reports based on the input and output flows as indicated by the flows store. One skilled in the art will appreciate that various embodiments may not include all these components and/or may include additional components.

The computing devices on which environmental impact systems are implemented may include a central processing unit, memory, input devices (e.g., keyboard and pointing devices), output devices (e.g., display devices), and storage devices (e.g., disk drives). The memory and storage devices are computer-readable media that may contain instructions that implement the environmental impact system. In addition, the data structures and message structures may be stored or transmitted via a data transmission medium, such as a signal on a communications link. Various communications links may be used, such as the Internet, a local area network, a wide area network, or a point-to-point dial-up connection.

The environmental impact system may be implemented or used in various operating environments that include personal computers, server computers, handheld or laptop devices, multiprocessor systems, microprocessor-based systems, programmable consumer electronics, network PCs, minicomputers, mainframe computers, distributed computing environments that include any of the above systems or devices, and the like.

The components of the environmental impact system may be described in the general context of computer-executable instructions, such as program modules, executed by one or more computers or other devices. Generally, program modules include routines, programs, objects, components, data structures, and so on, that perform particular tasks or implement particular abstract data types. Typically, the functionality of the program modules may be combined or distributed as desired in various embodiments.

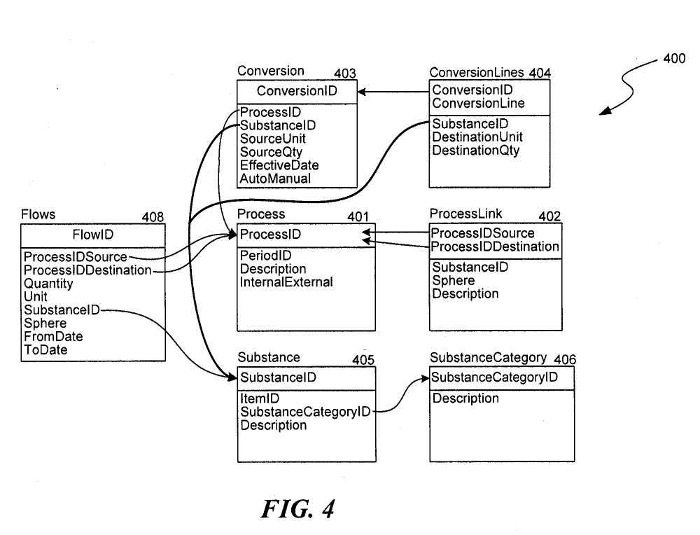

FIG. 4 is a block diagram illustrating a database for storing a model and associated flows in some embodiments of an environmental impact system. The database 400 includes a process table 401 and a process link table 402. The process table includes an entry (e.g., row or record) for each process of the model. Each entry may include a unique process identifier and a description of the process. The process link table includes an entry for each link between a pair of processes. Each entry identifies a source process and a destination process and includes an indication of the substances that the links represent (e.g., CO₂ flowing from a manufacturing process to a process representing the air). The database also includes a conversion table 403 and a conversion line table 404. The conversion table includes an entry for each type of conversion and identifies a process that performs the conversion, the substance being converted, and the common source quantity and the common source unit for the substance. The conversion lines table includes an entry for each output substance of each conversion. Each entry identifies the output substance along with a destination quantity and destination unit of the substance. For each common source unit and common source quantity for the source substance that is input into the process, the corresponding destination substance(s) of the destination unit and destination quantity are output by that process. The database includes a substance table 405 and a substance category table 406. The substance table includes an entry for each substance along with an indication of the type of the substance. The substance type table contains an entry for each type of substance along with an indication of the category of that substance. The substance category table contains an entry for each category of types of substances. For example, a substance may be diesel fuel, a substance type may be petroleum, and a substance category may be energy. The database also includes a flow table 408 with an entry for each substance flow (e.g., waste flows, intermediate flows, and external flows) and a map of each flow generated from the conversion of substances input into the processes. Each entry identifies a source process and a destination process along with a substance identifier and a quantity and unit for the substance. For example, when a user inputs natural gas bill information into an ERP system, the environmental impact system may create a initial input flow for the quantity of natural gas indicated by the bill for the source process (e.g., utility company) to the destination process (e.g., boiler).

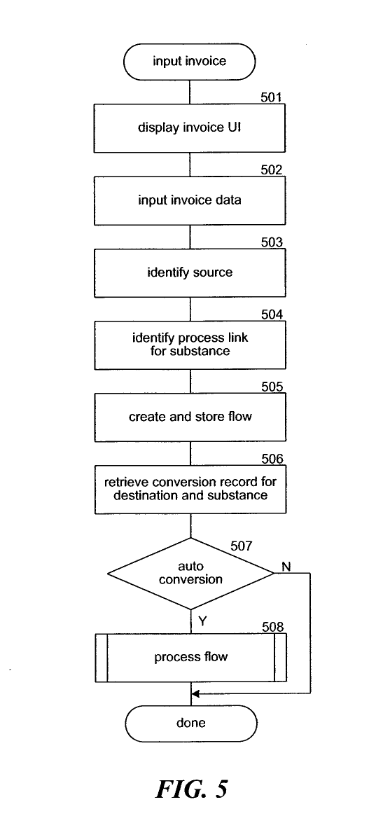

FIG. 5 is a flow diagram that illustrates the processing of an input invoice component of an environmental impact system in some embodiments. The component is an example of how input into an ERP system may be adapted to input flows into an environmental impact system. In block 501, the component may display an invoice user interface. In block 502, the component inputs the input data from a user indicating a quantity of a specified substance. In block 503, the component identifies the source process of the input data (e.g., a utility for a natural gas invoice) from the model store. In block 504, the component identifies a process link between the identified source process including a destination process for the specified substance. In block 505, the component creates and stores an initial input flow entry in the flows store. In block 506, the component retrieves from the model store a conversion record corresponding to the destination process (if one exists) and the specified substance. In decision block 507, if the entry indicates that an automatic conversion should be performed at this time, then the component continues at block 508, else the component completes. In block 508, the component invokes the process flows component to transitively process the input flow and its constituent output flows. The component then completes.

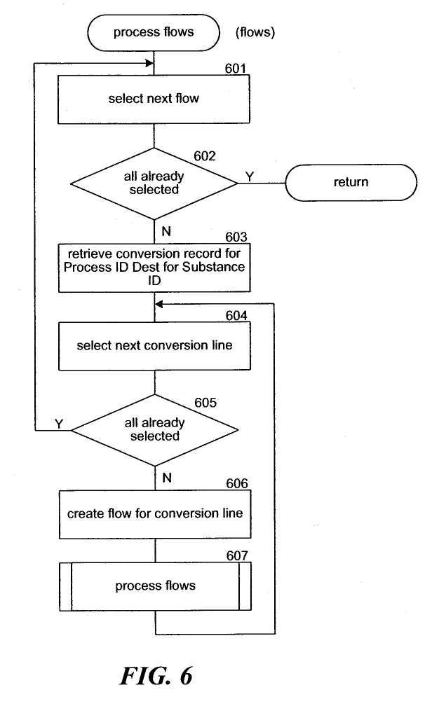

FIG. 6 is a flow diagram that illustrates the processing of a process flows component of an environmental impact system in some embodiments. The component is passed an indication of the flows and then loops through the steps for processing the conversions for each flow and recursively invoking the process flows component to further process any output flows until no more flows can be generated. In blocks 601-607, the component loops through the steps for processing each passed flow. In block 601, the component selects the next flow. In decision block 602, if all the flows have already been selected, then the component returns, else the component continues at block 603. In block 603, the component retrieves the conversion entry for the destination process for the substance identified by the selected flow. In blocks 604-607, the component loops through the steps for generating output flows from the conversion. In block 604, the component selects the next conversion line for the retrieved conversion entry. In decision block 605, if all the conversion lines have already been selected, then the component loops to block 601 to select the next flow, else the component continues at block 606. In block 606, the component creates a flow for the selected conversion line and stores an entry in the flows store. In block 607, the component recursively invokes the process flows component to process the created flow. The component then loops to block 604 to select the next conversion line.

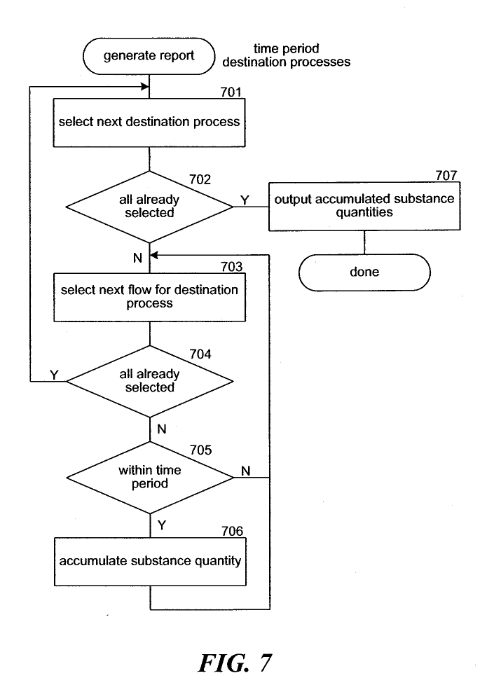

FIG. 7 is a flow diagram that illustrates the processing of the generate report component of an environmental impact system in some embodiments. The component may be passed a time period for and an indication of destination processes. The component generates a report indicating the substance of flows into the destination processes during a specified time period. For example, the destination processes may be all processes associated with the ecosphere. In block 701, the component selects the next destination process. In decision block 702, if all the destination processes have already been selected, then the component continues at block 707, else the component continues at block 703. In blocks 703-706, the component loop through the steps for selecting each flow for the selected destination process. In block 703, the component selects the next flow for the selected destination process. In decision block 704, if all the flows have already been selected, then the component loops to block 701 to select the next destination process, else the component continues at block 705. In decision block 705, if the selected flow is within the specified time period, then the component continues at block 706, else the component loops to block 703 to select the next flow. In block 706, the component accumulates the flow of the substance for that time period and then loops to block 703 to select the next flow. In block 707, the component outputs an indication of the accumulated substances and their quantities as a report and then completes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims. An intermediate flow of a process may be a flow generated as a result of conversion of an input substance that is further converted into an output substance. An intermediate flow may be designated by a link from a process to itself. The processes of a model may be hierarchically organized. The environmental impact system may allow each high-level process to have lower-level subprocesses. The environmental impact system may allow the user to view a representation of the model at different levels of the hierarchy. Accordingly, the invention is not limited except as by the appended claims.

I/We claim:

1. A method in a computing device for tracking the environmental impact of an organization using an enterprise resource planning system, the method comprising:
providing a description of processes of the organization;
providing a description of links between processes, each link specifying a source process and a destination process for a substance;
providing a description of conversions of substances input into the process to substances output as a result of those conversions;
generating of an initial input flow indicating input of a input substance into a process; and
transitively calculating output substances resulting from conversion of the input substance into output substances and generating flows corresponding to the output substances flowing into processes as indicated by the links between processes until no more flows can be generated.

2. The method of claim 1 wherein the initial input flow is generated upon entry of record of a sale or receipt received from a supplier of the input substance.

3. The method of claim 1 wherein the initial flow is generated from a meter measuring the quantity of the input substance supplied to the organization.

4. The method of claim 1 wherein the initial flow is generated upon receipt of electronic communication from a supplier indicating the quantity of the input substance provided by the supplier to the organization.

5. The method of claim 1 wherein a description of a conversion includes for each common quantity of a common unit of measure of an input substance, the resulting substances and the resulting quantities of resulting unit of measure.

6. The method of claim 1 wherein the initial input flow includes an indication of a time period for which the input substance was supplied to the organization.

7. The method of claim 1 including providing a user interface through which a description of a conversion can be provided.

8. The method of claim 1 wherein a process represents the release of a substance into the ecosphere.

9. The method of claim 8 including generating a report indicating the quantity of a substance released into the ecosphere over a time period based on analysis of manually or automatically generated flows of the substance into processes representing the ecosphere.

10. The method of claim 1 wherein a conversion specifies substances released into the ecosphere during the generation of the input substance.

11. A computing device for tracking environmental impact of an organization comprising:
a component that provides a user interface for inputting processes of the organization, links specifying source processes and destination processes for a substance, and conversions of substances input into the source process to substances output as a result of those conversions;
a component that generates initial input flows indicating the input of input substances into processes of the organization; and
a component that processes flows by calculating output substances resulting from the conversion of the input substances indicated by a flow into output substances and generates flows corresponding to the output substances flowing into processes as indicated by the links between processes,
wherein the component further processes any flows that are generated.

12. The computing device of claim 11 wherein a conversion includes for each common quantity of a common unit of measure of an input substance, the resulting substance(s) and the resulting quantity(ies) of resulting unit(s) of measure.

13. The computing device of claim 11 wherein the initial input flow includes an indication of a time period for which the input substance was supplied to the organization.

14. The computing device of claim 11 including providing a user interface through which a description of a conversion can be provided.

15. The computing device of claim 11 wherein a process represents the release of substances into the ecosphere.

16. The computing device of claim 15 including a component that generates a report indicating the quantity of a substance released into the ecosphere over a time period based on analysis of generated flows of the substance into processes representing the ecosphere.

17. A computer-readable storage medium containing instructions for controlling a computing device to track the environmental impact of an organization, by a method comprising:
providing a description of processes of the organization, each process representing a function of the organization, a function of a supplier of a substance to an organization, or a function relating to the ecosphere;
providing a description of links between processes, each link specifying a source process and a destination process for a substance, the source process for outputting the substance and the destination process for inputting the substance;
providing a description of conversions of substances input into a process to substances output as a result of that conversions, a conversion indicating for each common quantity in a common unit of measure of an input substance, the resulting substance(s) and the resulting quantity(ies) in resulting unit(s) of measure generated as a result of conversion of an input substance;
generating initials input flows indicating the input of input substances into processes, the initial input flow being generated from invoices of a supplier of an input substance and from meters measuring the quantity of input substances supplied to the organization; and
transitively calculating output substances resulting from conversion of the input substances into output substances and generating flows corresponding to the output substances flowing into processes as indicated by the links between processes until no more flows can be generated.

18. The computer-readable storage medium of claim 17 including generating a report indicating the quantity of a substance released into the ecosphere over a time period based on analysis of generated flows of the substance into processes representing the ecosphere.

19. The computer-readable storage medium of claim 17 wherein the initial input flow includes an indication of a time period for which the input substance was supplied to the organization.

20. The computer-readable storage medium of claim 17 wherein the generation of the input initial flows is integrated with an invoicing component of the enterprise resource planning system so that flows are automatically generated when a user inputs invoice information into the enterprise resource planning system.
